(19) United States
(12) Patent Application Publication
(10) Pub. No.: US 2019/0063949 A1
(43) Pub. Date: Feb. 28, 2019

(54) Step Counting Method and Apparatus

(71) Applicant: Huawei Technologies Co., Ltd., Shenzhen (CN)

(72) Inventors: Heng Liao, Shenzhen (CN); Yi Sun, Shenzhen (CN); Xueyan Huang, Shenzhen (CN)

(21) Appl. No.: 16/172,341

(22) Filed: Oct. 26, 2018

Related U.S. Application Data
(63) Continuation of application No. PCT/CN2017/082933, filed on May 3, 2017.

(30) Foreign Application Priority Data
Nov. 11, 2016 (CN) 201610998245.7

(51) Int. Cl. G01C 22/00; G06K 9/00; G06F 1/16

(52) U.S. Cl. CPC G01C 22/006; G06F 1/163; G06K 9/00348

(57) ABSTRACT

A step counting apparatus collects wearing limb information, determines, based on the wearing limb information, a type of the target limb on which a user wears the step counting apparatus, collects, in a step counting period, step counting information of the target limb, searches for, in a correspondence between a type of limb and a step counting criterion reference information, target step counting criterion reference information corresponding to the target limb, determines, based on the step counting information and the target step counting criterion reference information, whether the user is in a walking state in the step counting period, and calculates a quantity of steps based on the step counting information when the user is in a walking state in the step counting period.

### CROSS-REFERENCE TO RELATED APPLICATIONS

This application is a continuation of International Patent Application No. PCT/CN2017/082933 filed on May 3, 2017, which claims priority to Chinese Patent Application No. 201610998245.7 filed on Nov. 11, 2016. The disclosures of the aforementioned applications are hereby incorporated by reference in their entireties.

### TECHNICAL FIELD

This application relates to the field of communications technologies, and in particular, to a step counting method and apparatus.

### BACKGROUND

With society development, people pay more attention to fitness. For scientific fitness, some metering tools are usually used to calculate an amount of exercise. For example, a pedometer is used to monitor daily exercise progress, and calculate a quantity of walking steps, a walking distance, and the like. The pedometer currently used on the market is mainly an acceleration sensor or a gyroscope. The pedometer is disposed in a wearable collection device, directly worn, or attached to clothes or accessories of a user to calculate a quantity of walking steps by collecting period, amplitude, acceleration, or waveform information in a time domain or frequency domain when a limb wearing the pedometer vibrates. A vibration signal collected by the pedometer is not necessarily caused by walking of the user, but may alternatively be caused by another reason, such as an arm movement during tooth brushing, an arm movement during keyboard input, or low-amplitude leg shaking. In an existing step counting method, step counting is performed for all these movements caused by non-walking. Therefore, a quantity of steps counted is inaccurate.

In summary, it is urgent currently to reduce a step counting error and improve step counting precision.

### SUMMARY

An objective of the present disclosure is to provide a step counting method and apparatus to resolve a problem of low step counting precision in other approaches.

According to a first aspect, an embodiment of the present disclosure provides a step counting method, where the method includes collecting, by a step counting apparatus, wearing limb information, where the wearing limb information is used to represent related characteristic information of a limb on which a user wears the step counting apparatus, determining, by the step counting apparatus based on the wearing limb information, a type of the limb wearing the step counting apparatus, where the type of the limb includes a dominant limb or a non-dominant limb, collecting, by the step counting apparatus in a step counting period, step counting information of the limb wearing the step counting apparatus, where the step counting information is information used for calculating a quantity of steps, and collection of the step counting information and collection of the wearing limb information may be simultaneously performed, searching for, by the step counting apparatus in a correspondence between the type of the limb and step counting criterion reference information, step counting criterion reference information corresponding to the limb wearing the step counting apparatus in the step counting period, where the correspondence between the type of the limb and the step counting criterion reference information may be pre-learned or preset, and step counting criterion reference information corresponding to a dominant limb or a non-dominant limb is obtained by processing different step counting information collected when a plurality of users wear the step counting apparatus on the dominant limb or the non-dominant limb in a walking state, the step counting criterion reference information may be obtained by preprocessing different step counting information collected when the plurality of users wear the step counting apparatus on the dominant limb or the non-dominant limb in a walking state, and the preprocessing may include use of a statistical method, a machine learning method, or a method of setting an empirical value, determining, by the step counting apparatus based on the step counting information and the found step counting criterion reference information, whether the user is in a walking state in the step counting period, and calculating, by the step counting apparatus, a quantity of steps based on the step counting information when the user is in a walking state in the step counting period.

In this embodiment of the present disclosure, the step counting apparatus determines a limb type of the wearing limb based on the collected wearing limb information, and determines, based on the determined step counting criterion reference information corresponding to the limb wearing the step counting apparatus and the collected step counting information of the limb wearing the step counting apparatus, whether the user is in a walking state in the step counting period. Limb types of wearing limbs are distinguished, and corresponding step counting criterion reference information is set for different limb types such that a step counting error is reduced, and step counting precision is improved.

In a possible design, the step counting apparatus discards the step counting information when the user is in a non-walking state in the step counting period.

In a possible design, after calculating, by the step counting apparatus, a quantity of steps based on the step counting information, the method further includes adding, by the step counting apparatus, the calculated quantity of steps to a total quantity of steps accumulated at the end of a previous step counting period of the step counting period, or after the step counting apparatus discards the step counting information, the method further includes using, by the step counting apparatus, a total quantity of steps accumulated at the end of a previous step counting period of the step counting period as a total quantity of steps accumulated at the end of the step counting period.

In this embodiment of the present disclosure, the step counting apparatus adds the calculated quantity of steps to the total quantity of steps accumulated at the end of the previous step counting period of the step counting period, or uses the total quantity of steps accumulated at the end of the previous step counting period of the step counting period as a total quantity of steps accumulated at the end of the step counting period such that step counting precision of the step counting apparatus is improved.

In a possible design, the step counting criterion reference information includes a parameter threshold corresponding to at least one specified parameter, where the specified parameter may be a difference between a probability that the wearing limb is in a walking state and a probability that the wearing limb is in a non-walking state, a vibration frequency of the wearing limb, or a vibration amplitude of the wearing limb.

Determining, by the step counting apparatus based on the step counting information and the found step counting criterion reference information, whether the user is in a walking state in the step counting period includes determining, by the step counting apparatus, a parameter value of the at least one specified parameter of the step counting information, determining that the user is in a walking state in the step counting period if the determined parameter value of the at least one specified parameter exceeds the parameter threshold of the corresponding specified parameter, and determining that the user is in a non-walking state in the step counting period if the determined parameter value of the at least one specified parameter does not exceed the parameter threshold of the corresponding specified parameter.

In this embodiment of the present disclosure, different parameter thresholds are set based on different specified parameters, and whether the user is in a walking state is determined using the specified parameter threshold such that step counting precision of the step counting apparatus is improved.

In a possible design, the method further includes searching for, by the step counting apparatus in a correspondence between the type of the limb and a filtering manner, a filtering manner corresponding to the limb wearing the step counting apparatus in the step counting period, where the correspondence between the type of the limb and the filtering manner may be pre-learned or preset, and before determining, by the step counting apparatus based on the step counting information and the found step counting criterion reference information, whether the user is in a walking state in the step counting period, the method further includes performing, by the step counting apparatus, filtering process on the step counting information using the determined filtering manner.

In this embodiment of the present disclosure, a corresponding filtering relationship is determined based on the determined limb type, and filtering is performed on the step counting information such that step counting precision of the step counting apparatus is further improved.

According to a second aspect, an embodiment of the present disclosure provides a step counting method, where the method includes collecting, by a step counting apparatus, wearing limb information, where the wearing limb information is used to represent related characteristic information of a limb on which a user wears the step counting apparatus, determining, by the step counting apparatus based on the wearing limb information, a type of the limb wearing the step counting apparatus, where the type of the limb includes a dominant limb or a non-dominant limb, collecting, by the step counting apparatus in a step counting period, step counting information of the limb wearing the step counting apparatus, where the step counting information is information used for calculating a quantity of steps, searching for, by the step counting apparatus in a correspondence between the type of the limb and a filtering manner, a filtering manner corresponding to the limb wearing the step counting apparatus in the step counting period, where the correspondence between the type of the limb and the filtering manner is pre-learned or preset, performing, by the step counting apparatus, filtering process on the step counting information using the determined filtering manner, to determine filtered step counting information, determining, by the step counting apparatus based on the filtered step counting information, whether the user is in a walking state in the step counting period, and calculating, by the step counting apparatus, a quantity of steps based on the step counting information when the user is in a walking state in the step counting period.

In this embodiment of the present disclosure, the step counting apparatus determines a limb type of the wearing limb based on the collected wearing limb information, determines a corresponding filtering manner based on the limb type, and determines, based on the filtered step counting information, whether the user is in a walking state in the step counting period. Limb types of wearing limbs are distinguished, and corresponding filtering manners are set for different limb types such that a step counting error is reduced, and step counting precision is improved.

In a possible design, the step counting apparatus discards the step counting information when the user is in a non-walking state in the step counting period.

According to a third aspect, an embodiment of the present disclosure provides a step counting apparatus, where the apparatus includes a collection module configured to collect wearing limb information, where the wearing limb information is used to represent related characteristic information of a limb on which a user wears the step counting apparatus, a processing module configured to determine, based on the wearing limb information, a type of the limb wearing the step counting apparatus, where the type of the limb includes a dominant limb or a non-dominant limb, the collection module is further configured to collect, in a step counting period, step counting information of the limb wearing the step counting apparatus, where the step counting information is information used for calculating a quantity of steps, a search module configured to search for, in a correspondence between the type of the limb and step counting criterion reference information, step counting criterion reference information corresponding to the limb wearing the step counting apparatus in the step counting period, where step counting criterion reference information corresponding to a dominant limb or a non-dominant limb is obtained by processing different step counting information collected when a plurality of users wear the step counting apparatus on the dominant limb or the non-dominant limb in a walking state, a determining module configured to determine, based on the step counting information and the found step counting criterion reference information, whether the user is in a walking state in the step counting period, and the determining module is further configured to calculate a quantity of steps based on the step counting information when the user is in a walking state in the step counting period.

In this embodiment of the present disclosure, the step counting apparatus determines a limb type of the wearing limb based on the collected wearing limb information, and determines, based on the determined step counting criterion reference information corresponding to the limb wearing the step counting apparatus and the collected step counting information of the limb wearing the step counting apparatus, whether the user is in a walking state in the step counting period. Limb types of wearing limbs are distinguished, and corresponding step counting criterion reference information is set for different limb types such that a step counting error is reduced, and step counting precision is improved.

In a possible design, after calculating the quantity of steps based on the step counting information, the determining module is further configured to add the calculated quantity of steps to a total quantity of steps accumulated at the end of a previous step counting period of the step counting period, or after discarding the step counting information, the determining module is further configured to use a total quantity of steps accumulated at the end of a previous step counting period of the step counting period as a total quantity of steps accumulated at the end of the step counting period.

In a possible design, the step counting criterion reference information includes a parameter threshold corresponding to at least one specified parameter, and determining, by the step counting apparatus based on the step counting information and the found step counting criterion reference information, whether the user is in a walking state in the step counting period includes determining, by the step counting apparatus, a parameter value of the at least one specified parameter of the step counting information, determining that the user is in a walking state in the step counting period if the determined parameter value of the at least one specified parameter exceeds the parameter threshold of the corresponding specified parameter, and determining that the user is in a non-walking state in the step counting period if the determined parameter value of the at least one specified parameter does not exceed the parameter threshold of the corresponding specified parameter.

In a possible design, the at least one specified parameter includes a difference between a probability that the wearing limb is in a walking state and a probability that the wearing limb is in a non-walking state, and in a possible design, the at least one specified parameter further includes a vibration frequency of the wearing limb or a vibration amplitude of the wearing limb.

In a possible design, the search module is further configured to search for, in the correspondence between the type of the limb and a filtering manner, a filtering manner corresponding to the limb wearing the step counting apparatus in the step counting period, where the correspondence between the type of the limb and the filtering manner is pre-learned or preset, and before determining, based on the step counting information and the found step counting criterion reference information, whether the user is in a walking state in the step counting period, the processing module is further configured to perform filtering process on the step counting information using the determined filtering manner.

According to a fourth aspect, an embodiment of the present disclosure provides a step counting apparatus, where the apparatus includes a collection module configured to collect wearing limb information, where the wearing limb information is used to represent related characteristic information of a limb on which a user wears the step counting apparatus, a processing module configured to determine, based on the wearing limb information, a type of the limb wearing the step counting apparatus, where the type of the limb includes a dominant limb or a non-dominant limb, the collection module is further configured to collect, in a step counting period, step counting information of the limb wearing the step counting apparatus, where the step counting information is information used for calculating a quantity of steps, a search module configured to search for, in a correspondence between the type of the limb and a filtering manner, a filtering manner corresponding to the limb wearing the step counting apparatus in the step counting period, where the correspondence between the type of the limb and the filtering manner is pre-learned or preset, the processing module is further configured to perform filtering process on the step counting information using the determined filtering manner, to determine filtered step counting information, a determining module, configured for the step counting apparatus to determine, based on the filtered step counting information, whether the user is in a walking state in the step counting period, and the determining module is further configured to calculate a quantity of steps based on the step counting information when the step counting apparatus determines that the user is in a walking state in the step counting period.

In this embodiment of the present disclosure, the step counting apparatus determines a limb type of the wearing limb based on the collected wearing limb information, determines a corresponding filtering manner based on the limb type, and determines, based on the filtered step counting information, whether the user is in a walking state in the step counting period. Limb types of wearing limbs are distinguished, and corresponding filtering manners are set for different limb types such that a step counting error is reduced, and step counting precision is improved.

According to fifth aspect, an embodiment of the present disclosure provides a step counting apparatus, including a processor and a memory, where the memory is configured to store a software program, and the processor is configured to read the software program stored in the memory, to implement any one of the first aspect, any possible design of the first aspect, the second aspect, or any possible design of the second aspect.

According to a sixth aspect, an embodiment of the present disclosure provides a computer readable storage medium, including an instruction, which enables a computer to implement any one of the first aspect, any possible design of the first aspect, the second aspect, or any possible design of the second aspect when the instruction runs on the computer.

In this embodiment of the present disclosure, the step counting apparatus determines a limb type of the wearing limb based on the collected wearing limb information, and determines, based on the determined step counting criterion reference information corresponding to the limb wearing the step counting apparatus and the collected step counting information of the limb wearing the step counting apparatus, whether the user is in a walking state in the step counting period. Limb types of wearing limbs are distinguished, and corresponding step counting criterion reference information is set for different limb types such that a step counting error is reduced, and step counting precision is improved.

### BRIEF DESCRIPTION OF DRAWINGS

FIG. 1 is a schematic flowchart of a step counting method according to an embodiment of the present disclosure;

FIG. 2 is a schematic flowchart of another step counting method according to an embodiment of the present disclosure;

FIG. 3 is a schematic structural diagram of a step counting apparatus according to an embodiment of the present disclosure;

FIG. 4 is a schematic structural diagram of another step counting apparatus according to an embodiment of the present disclosure; and

FIG. 5 is a schematic structural diagram of hardware of a step counting apparatus according to an embodiment of the present disclosure.

### DESCRIPTION OF EMBODIMENTS

The following further describes the embodiments of the present disclosure in detail with reference to this specification. It should be understood that the embodiments described herein are merely used to explain the present disclosure but are not intended to limit the present disclosure.

A user uses a step counting apparatus to monitor daily exercise progress and calculate a quantity of walking steps. The step counting apparatus may be worn at different locations, and collected vibration signals are not necessarily caused by a walking action of the user. In an existing step counting method, a location at which the step counting apparatus is worn is not determined for collecting vibration signals, resulting in inaccurate step counting. In the embodiments of the present disclosure, the step counting apparatus determines collected step counting information based on different limb types such that step counting precision is improved, and a step counting error is reduced.

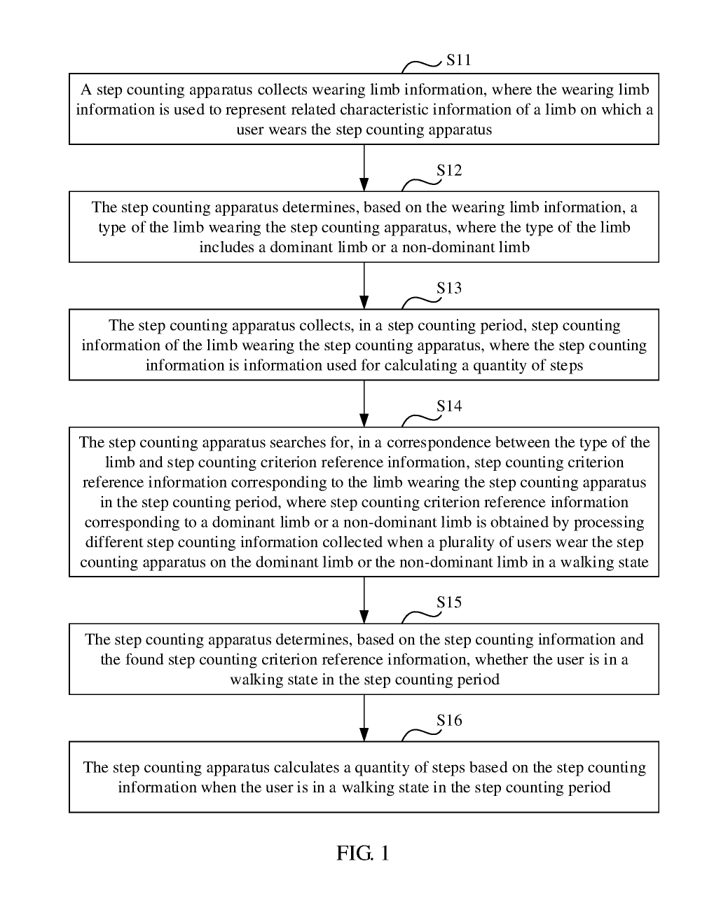

An embodiment of the present disclosure provides a step counting method. As shown in FIG. 1, the method includes the following process.

Step S11. A step counting apparatus collects wearing limb information, where the wearing limb information is used to represent related characteristic information of a limb on which a user wears the step counting apparatus.

Optionally, the step counting apparatus may be a wearable device, such as a smart watch or a smart band, or may be a portable device, such as a smart phone.

Optionally, the step counting apparatus may be a system, and the system includes a wearable device, a mobile intelligent device connected to the wearable device, a network cloud server directly or indirectly connected to the wearable device, or the like.

Step S12. The step counting apparatus determines, based on the wearing limb information, a type of the limb wearing the step counting apparatus, where the type of the limb includes a dominant limb or a non-dominant limb.

Further, the dominant limb is a limb most commonly used by a wearer, and the non-dominant limb is a limb of wearer limbs except the dominant limb, such as a hand, a foot, a finger, or another limb. If the wearer's commonly used hand is the left hand, the wearer's dominant limb is the left hand and the non-dominant limb is the right hand, or if the wearer's commonly used hand is the right hand, the wearer's dominant limb is the right hand and the non-dominant limb is the left hand. The dominant limb and the non-dominant limb are used at different frequencies, and differences are presented over time. The differences include that the dominant limb is thicker than the non-dominant limb, the dominant limb is rougher than the non-dominant limb, and surface skin of the dominant limb is thicker than that of the non-dominant limb such that a pH of the user's dominant limb is significantly higher than that of the non-dominant limb, according to a skin conductivity principle, there is a statistically significant difference between skin conductivity of the user's dominant hand and that of the non-dominant hand, that is, a variance between a skin conductivity signal of the dominant hand and that of the non-dominant hand is less than or equal to 0.05, or temperature of the dominant limb is higher than that of the non-dominant limb, blood oxygen saturation of the dominant limb is higher than that of the non-dominant limb, and a photoelectric pulse wave signal of the dominant limb is different from that of the non-dominant limb. Information about the dominant limb and the non-dominant limb is collected when the step counting apparatus is worn, and statistical collection is performed on a large amount of repeated collected data in order to obtain parameter information corresponding to the dominant limb or the non-dominant limb.

In this embodiment of the present disclosure, the wearing limb information is collected, including at least one of body temperature, blood oxygen, chemical pH information, or other information, and a type of a wearing limb is determined using the pre-obtained parameter information corresponding to the dominant limb or the non-dominant limb. For example, based on a scientific research, a variance between a skin conductivity signal of a dominant hand and that of a non-dominant hand is less than or equal to 0.05. A threshold for distinguishing conductivity signals between the dominant limb and the non-dominant limb may be set, and conductivity signals of the wearing limb may be collected. If a conductivity signal is greater than the conductivity signal threshold, it is determined that the step counting apparatus is worn on the dominant limb.

Step S13. The step counting apparatus collects, in a step counting period, step counting information of the limb wearing the step counting apparatus, where the step counting information is information used for calculating a quantity of steps.

Optionally, the step counting information may include a vibration period, a vibration amplitude, waveform information, vibration acceleration information in each direction, and the like, of the wearing limb, in a time domain or a frequency domain in each direction.

For example, calculating a quantity of steps of the step counting object using the step counting information includes collecting vibration amplitudes of the wearing limb in various directions, for example, in X, Y, and Z directions, and generating a time-variant waveform graph. The quantity of steps is calculated based on a quantity of waveforms in the waveform graph. When the quantity of waveforms is calculated, a concept of a frequency threshold or a frequency interval may also be introduced. Waveforms within the frequency interval range or the threshold range are counted into the quantity of waveforms, and other waveforms are not counted into the quantity of waveforms.

Step S14. The step counting apparatus searches for, in a correspondence between the type of the limb and step counting criterion reference information, step counting criterion reference information corresponding to the limb wearing the step counting apparatus in the step counting period, where the correspondence between the type of the limb and the step counting criterion reference information may be pre-learned or preset, and step counting criterion reference information corresponding to a dominant limb or a non-dominant limb is obtained by processing different step counting information collected when a plurality of users wear the step counting apparatus on the dominant limb or the non-dominant limb in a walking state.

Further, the step counting criterion reference information may be obtained by preprocessing different step counting information collected when the plurality of users wear the step counting apparatus on the dominant limb or the non-dominant limb in a walking state, and the preprocessing may be performed using a statistical method, a machine learning method, or an empirical value setting method.

Step S15. The step counting apparatus determines, based on the step counting information and the found step counting criterion reference information, whether the user is in a walking state in the step counting period.

Optionally, the step counting criterion reference information includes a parameter threshold corresponding to at least one specified parameter, the determining, by the step counting apparatus based on the step counting information and the found step counting criterion reference information, whether the user is in a walking state in the step counting period includes determining, by the step counting apparatus, a parameter value of the at least one specified parameter of the step counting information, and if the determined parameter value of the at least one specified parameter exceeds the parameter threshold of the corresponding specified parameter, determining that the user is in a walking state in the step counting period, if the determined parameter value of the at least one specified parameter does not exceed the parameter threshold of the corresponding specified parameter, determining that the user is in a non-walking state in the step counting period.

Optionally, the at least one specified parameter includes a difference between a probability that the wearing limb is in a walking state and a probability that the wearing limb is in a non-walking state, a vibration frequency of the wearing limb, or a vibration amplitude of the wearing limb.

Examples are used for illustration.

### Example 1

A probability that the user is in a walking state and a probability that the user is in a non-walking state are calculated based on the step counting information. If the step counting apparatus is worn on the dominant limb of the user, and a difference between the probability that the user is in a walking state and the probability that the step counting object is in a non-walking state is greater than a first threshold, it is determined that the user is in a walking state, if a difference between the probability that the user is in a walking state and the probability that the step counting object is in a non-walking state is less than or equal to the first threshold, it is determined that the user is in a non-walking state. If the step counting apparatus is worn on the non-dominant limb of the user, and a difference between the probability that the user is in a walking state and the probability that the step counting object is in a non-walking state is greater than a second threshold, it is determined that the user is in a walking state, if a difference between the probability that the user is in a walking state and the probability that the step counting object is in a non-walking state is less than or equal to the second threshold, it is determined that the user is in a non-walking state, where the first threshold is greater than the second threshold.

The probability of being in a walking state is calculated using a walking-state probability function, and the probability of being in a non-walking state is calculated using a non-walking-state probability function. A step counting function or a non-step-counting function is calculated based on at least one piece of the step counting information using a linear function, a forward function, or a reverse function. This is not limited in this embodiment of the present disclosure.

### Example 2

If the step counting apparatus is worn on the dominant limb of the user, and the collected vibration frequency or vibration amplitude of the wearing limb is greater than a third threshold, it is determined that the user is in a walking state, if the step counting apparatus is worn on the non-dominant limb of the user, and the collected vibration frequency or vibration amplitude of the wearing limb is greater than a fourth threshold, it is determined that the user is in a walking state, where the third threshold is greater than the fourth threshold.

Step S16. The step counting apparatus calculates a quantity of steps based on the step counting information when the user is in a walking state in the step counting period.

Optionally, the step counting apparatus discards the step counting information when the user is in a non-walking state in the step counting period.

In this embodiment of the present disclosure, the step counting apparatus determines a limb type of the wearing limb based on the collected wearing limb information, and determines, based on the determined step counting criterion reference information corresponding to the limb wearing the step counting apparatus and the collected step counting information of the limb wearing the step counting apparatus, whether the user is in a walking state in the step counting period. Limb types of wearing limbs are distinguished, and corresponding step counting criterion reference information is set for different limb types such that a step counting error is reduced, and step counting precision is improved.

In a possible implementation, after the step counting apparatus calculates the quantity of steps based on the step counting information in step S16, the method further includes adding, by the step counting apparatus, the calculated quantity of steps to a total quantity of steps accumulated at the end of a previous step counting period of the step counting period.

After the step counting apparatus discards the step counting information in step S16, the method further includes using, by the step counting apparatus, the total quantity of steps accumulated at the end of the previous step counting period of the step counting period as a total quantity of steps accumulated at the end of the step counting period.

In a possible implementation, the step counting apparatus searches for, in a correspondence between the type of the limb and a filtering manner, a filtering manner corresponding to the limb wearing the step counting apparatus in the step counting period, where the correspondence between the type of the limb and the filtering manner is pre-learned or preset, and before the step counting apparatus determines, based on the step counting information and the found step counting criterion reference information, whether the user is in a walking state in the step counting period, the method further includes performing, by the step counting apparatus, filtering process on the step counting information using the determined filtering manner.

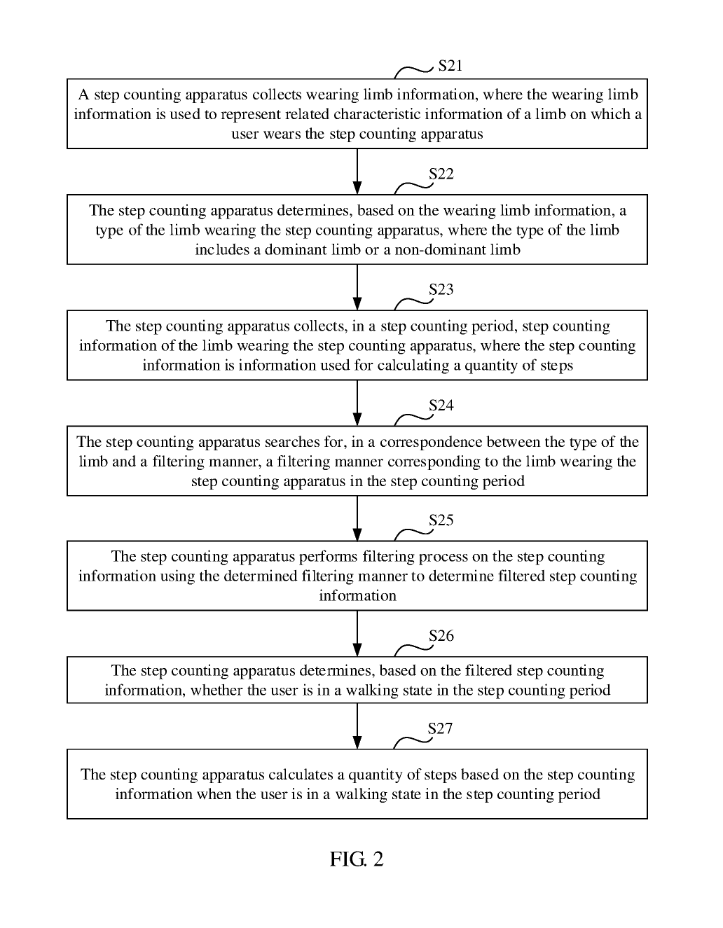

An embodiment of the present disclosure provides another step counting method. As shown in FIG. 2, the method includes the following process.

Step S21. A step counting apparatus collects wearing limb information, where the wearing limb information is used to represent related characteristic information of a limb on which a user wears the step counting apparatus.

Step S22. The step counting apparatus determines, based on the wearing limb information, a type of the limb wearing the step counting apparatus, where the type of the limb includes a dominant limb or a non-dominant limb.

Step S23. The step counting apparatus collects, in a step counting period, step counting information of the limb wearing the step counting apparatus, where the step counting information is information used for calculating a quantity of steps.

Step S24. The step counting apparatus searches for, in a correspondence between the type of the limb and a filtering manner, a filtering manner corresponding to the limb wearing the step counting apparatus in the step counting period.

Optionally, the correspondence between the type of the limb and the filtering manner is pre-learned or preset.

Further, if the step counting apparatus is worn on the dominant limb of the user, a first filter is matched, if the step counting apparatus is worn on the non-dominant limb of the user, a second filter is matched, where different filtering parameters are used by the first filter and the second filter. The first filter has a stronger filtering effect than the second filter, and can filter out more interference signals or noise. The second filter with a weak filtering effect is used for filtering step counting signals of a wearer wearing the step counting apparatus on a non-dominant limb, avoiding incorrectly filtering out more walking signals. In this embodiment of the present disclosure, the filter may be a high-pass filter, a low-pass filter, a band-pass filter, or a Fast Fourier Transform (FFT) filter, and may be configured to convert step counting information from time domain signals to frequency domain signals. Filtering parameters of a filter include a lower filtering limit of the high-pass filter, an upper filtering limit of the low-pass filter, an upper filtering limit or a lower filtering limit of the band-pass filter, an upper filtering limit, a lower filtering limit, or a sampling frequency of the FFT filter, or the like. This is not limited in this embodiment of the present disclosure.

Step S25. The step counting apparatus performs filtering process on the step counting information using the determined filtering manner to determine filtered step counting information.

Step S26. The step counting apparatus determines, based on the filtered step counting information, whether the user is in a walking state in the step counting period.

Further, if a periodic signal of the filtered step counting information includes a rise interval and a fall interval, the periodic signal is counted as one walking step, if an absolute value difference between a maximum value and a minimum value of a periodic signal of the filtered step counting information is greater than a fifth threshold, the periodic signal is counted as one walking step, if a proportion of a rising interval and that of a falling interval, of a periodic signal of the filtered step counting information, are approximate, the periodic signal is counted as one walking step.

Step S27. The step counting apparatus calculates a quantity of steps based on the step counting information when the user is in a walking state in the step counting period.

Optionally, the step counting apparatus discards the step counting information when the user is in a non-walking state in the step counting period.

In this embodiment of the present disclosure, the step counting apparatus determines a limb type of the wearing limb based on the collected wearing limb information, determines a corresponding filtering manner based on the limb type, and determines, based on the filtered step counting information, whether the user is in a walking state in the step counting period. Limb types of wearing limbs are distinguished, and corresponding filtering manners are set for different limb types such that a step counting error is reduced, and step counting precision is improved.

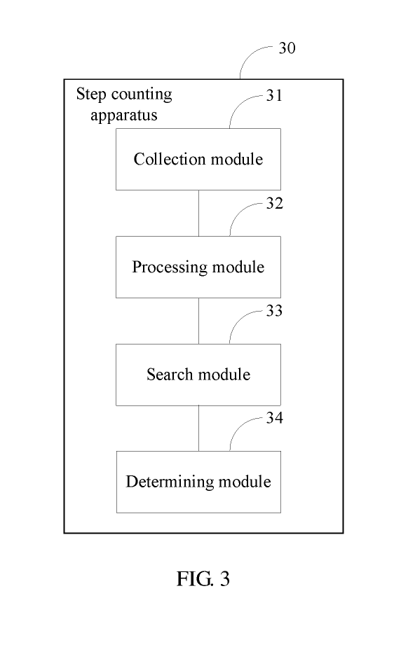

Based on the same inventive concept, an embodiment of the present disclosure provides a step counting apparatus. As shown in FIG. 3, a step counting apparatus 30 includes a collection module 31 configured to collect wearing limb information, where the wearing limb information is used to represent related characteristic information of a limb on which a user wears the step counting apparatus 30, a processing module 32 configured to determine, based on the wearing limb information, a type of the limb wearing the step counting apparatus 30, where the type of the limb includes a dominant limb or a non-dominant limb, and the collection module 31 is further configured to collect, in a step counting period, step counting information of the limb wearing the step counting apparatus 30, where the step counting information is information used for calculating a quantity of steps, a search module 33 configured to search for, in a correspondence between the type of the limb and step counting criterion reference information, step counting criterion reference information corresponding to the limb wearing the step counting apparatus 30 in the step counting period, where step counting criterion reference information corresponding to a dominant limb or a non-dominant limb is obtained by preprocessing different step counting information collected when a plurality of users wear the step counting apparatus on the dominant limb or the non-dominant limb in a walking state, and a determining module 34 configured to determine, based on the step counting information and the found step counting criterion reference information, whether the user is in a walking state in the step counting period, where the determining module 34 is further configured to calculate a quantity of steps based on the step counting information when the user is in a walking state in the step counting period.

In this embodiment of the present disclosure, the step counting apparatus 30 determines a limb type of the wearing limb based on the collected wearing limb information, and determines, based on the determined step counting criterion reference information corresponding to the limb wearing the step counting apparatus 30 and the collected step counting information of the limb wearing the step counting apparatus 30, whether the user is in a walking state in the step counting period. Limb types of wearing limbs are distinguished, and corresponding step counting criterion reference information is set for different limb types such that a step counting error is reduced, and step counting precision is improved.

Optionally, after calculating the quantity of steps based on the step counting information, the determining module 34 is further configured to add the calculated quantity of steps to a total quantity of steps accumulated at the end of a previous step counting period of the step counting period, or after discarding the step counting information, the determining module 34 is further configured to use a total quantity of steps accumulated at the end of a previous step counting period of the step counting period as a total quantity of steps accumulated at the end of the step counting period.

Optionally, the step counting criterion reference information includes a parameter threshold corresponding to at least one specified parameter, and determining, by the step counting apparatus 30 based on the step counting information and the found step counting criterion reference information, whether the user is in a walking state in the step counting period includes determining, by the step counting apparatus 30, a parameter value of the at least one specified parameter of the step counting information, and if the determined parameter value of the at least one specified parameter exceeds the parameter threshold of the corresponding specified parameter, determining that the user is in a walking state in the step counting period, if the determined parameter value of the at least one specified parameter does not exceed the parameter threshold of the corresponding specified parameter, determining that the user is in a non-walking state in the step counting period.

Optionally, the at least one specified parameter includes a difference between a probability that the wearing limb is in a walking state and a probability that the wearing limb is in a non-walking state.

Optionally, the at least one specified parameter further includes a vibration frequency of the wearing limb or a vibration amplitude of the wearing limb.

Optionally, the search module 33 searches for, in the correspondence between the type of the limb and a filtering manner, a filtering manner corresponding to the limb wearing the step counting apparatus 30 in the step counting period, where the correspondence between the type of the limb and the filtering manner is pre-learned or preset, and before determining, based on the step counting information and the found step counting criterion reference information, whether the user is in a walking state in the step counting period, the processing module 32 is further configured to perform filtering process on the step counting information using the determined filtering manner.

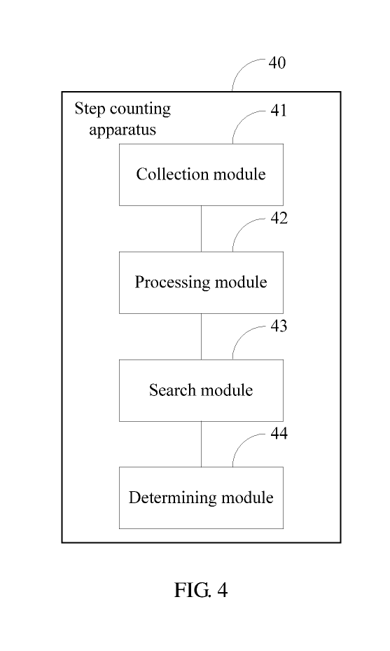

Based on the same inventive concept, an embodiment of the present disclosure provides a step counting apparatus 40 in FIG. 4. As shown in FIG. 4, the apparatus 40 includes a collection module 41 configured to collect wearing limb information, where the wearing limb information is used to represent related characteristic information of a limb on which a user wears the step counting apparatus, a processing module 42 configured to determine, based on the wearing limb information, a type of the limb wearing the step counting apparatus 40, where the type of the limb includes a dominant limb or a non-dominant limb, and the collection module 41 is further configured to collect, in a step counting period, step counting information of the limb wearing the step counting apparatus 40, where the step counting information is information used for calculating a quantity of steps, a search module 43 configured to search for, in a correspondence between the type of the limb and a filtering manner, a filtering manner corresponding to the limb wearing the step counting apparatus 40 in the step counting period, where the correspondence between the type of the limb and the filtering manner is pre-learned or preset, and the processing module 42 is configured to perform filtering process on the step counting information using the determined filtering manner to determine filtered step counting information, and a determining module 44 configured for the step counting apparatus to determine, based on the filtered step counting information, whether the user is in a walking state in the step counting period, where the determining module 44 is further configured to calculate a quantity of steps based on the step counting information when the step counting apparatus 40 determines that the user is in a walking state in the step counting period.

In this embodiment of the present disclosure, the step counting apparatus 40 determines a limb type of the wearing limb based on the collected wearing limb information, determines a corresponding filtering manner based on the limb type, and determines, based on the filtered step counting information, whether the user is in a walking state in the step counting period. Limb types of wearing limbs are distinguished, and corresponding filtering manners are set for different limb types such that a step counting error is reduced, and step counting precision is improved.

The following describes a structure and a processing manner of the apparatus provided by the embodiments of the present disclosure, with reference to a preferred hardware structure.

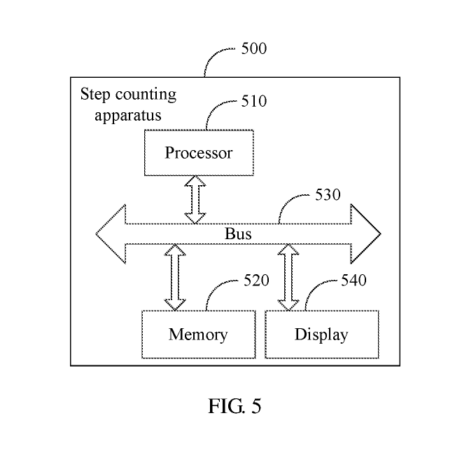

An embodiment of the present disclosure provides a step counting apparatus 500 in FIG. 5. As shown in FIG. 5, the step counting apparatus 500 includes a processor 510, a memory 520 connected to the processor 510, and a display 540 that is connected to a bus 530 and is configured to display a quantity of steps. The memory 520 and the processor 510 are connected to each other using the bus 530.

The memory 520 is configured to store program code to be executed by the processor 510.

The processor 510 is configured to execute the program code stored in the memory 520, and perform any step counting method provided by the foregoing embodiments, for example, perform the following process of collect wearing limb information, where the wearing limb information is used to represent related characteristic information of a limb on which a user wears the step counting apparatus, determine, based on the wearing limb information, a type of the limb wearing the step counting apparatus, where the type of the limb includes a dominant limb or a non-dominant limb, collect, in a step counting period, step counting information of the limb wearing the step counting apparatus, where the step counting information is information used for calculating a quantity of steps, search for, in a correspondence between the type of the limb and step counting criterion reference information, step counting criterion reference information corresponding to the limb wearing the step counting apparatus in the step counting period, where the correspondence between the type of the limb and the step counting criterion reference information may be pre-learned or preset, and step counting criterion reference information corresponding to a dominant limb or a non-dominant limb is obtained by preprocessing different step counting information collected when a plurality of users wear the step counting apparatus on the dominant limb or the non-dominant limb in a walking state, determine, based on the step counting information and the found step counting criterion reference information, whether the user is in a walking state in the step counting period, and calculate a quantity of steps based on the step counting information when the user is in a walking state in the step counting period.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a compact disc read-only memory (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine such that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner such that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device such that a series of operations and steps are performed on the computer or the other programmable device, thereby generating computer-implemented processing. Therefore, the instructions executed on the computer or the other programmable device provides steps for implementing a specific function in one or more processes in the flowcharts and/or in one or more blocks in the block diagrams.

Although some embodiments of the present disclosure have been described, a person skilled in the art can make changes and modifications to these embodiments once they learn the basic inventive concept. Therefore, the following claims are intended to be construed as to cover the embodiments and all changes and modifications falling within the scope of the present disclosure.

Obviously, a person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

What is claimed is:

1. A step counting method, comprising:
collecting, by a step counting apparatus, wearing limb information, the wearing limb information comprising related characteristic information of a target limb on which a user wears the step counting apparatus;
determining, by the step counting apparatus based on the wearing limb information, a type of the target limb;
collecting, by the step counting apparatus in a step counting period, step counting information of the target limb;
searching for, by the step counting apparatus based on the type of the target limb in a correspondence between a type of limb and a step counting criterion reference information, target step counting criterion reference information corresponding to the target limb;
determining, by the step counting apparatus based on the step counting information and the target step counting criterion reference information, whether the user is in a walking state in the step counting period; and
calculating, by the step counting apparatus, a quantity of steps based on the step counting information when the user is in the walking state in the step counting period.

2. The step counting method of claim 1, wherein after calculating the quantity of steps based on the step counting information, the method further comprises adding, by the step counting apparatus, the calculated quantity of steps to a total quantity of steps accumulated at an end of a previous step counting period of the step counting period.

3. The step counting method of claim 1, wherein the target step counting criterion reference information comprises a parameter threshold corresponding to a specified parameter, and determining whether the user being in the walking state in the step counting period comprises:
calculating, by the step counting apparatus based on the step counting information, a parameter value of the specified parameter; and
determining that the user is in the walking state in the step counting period when the parameter value of the specified parameter exceeds the parameter threshold of the specified parameter.

4. The step counting method of claim 3, wherein the specified parameter comprises a difference between a probability that a wearing limb is in the walking state and a probability that the wearing limb is in a non-walking state.

5. The step counting method of claim 3, wherein the specified parameter comprises a vibration frequency of a wearing limb.

6. The step counting method of claim 3, wherein the specified parameter comprises a vibration amplitude of a wearing limb.

7. The step counting method of claim 1, further comprising:
searching for, by the step counting apparatus based on the type of the target limb in a correspondence between the type of limb and a filtering manner, a target filtering manner corresponding to the target limb; and
performing, by the step counting apparatus, a filtering process on the step counting information using the target filtering manner before determining whether the user is in the walking state in the step counting period.

8. A step counting apparatus, comprising:
a non-transitory computer-readable storage medium storing programming instructions; and
a processor coupled to the non-transitory computer-readable storage medium, the programming instructions causing the processor to be configured to:
collect wearing limb information, the wearing limb information comprising related characteristic information of a target limb on which a user wears the step counting apparatus;
determine, based on the wearing limb information, a type of the target limb;
collect, in a step counting period, step counting information of the target limb;
search for, based on the type of the target limb in a correspondence between a type of limb and a step counting criterion reference information, target step counting criterion reference information corresponding to the target limb;
determine, based on the step counting information and the target step counting criterion reference information, whether the user is in a walking state in the step counting period; and
calculate a quantity of steps based on the step counting information when the user is in the walking state in the step counting period.

9. The step counting apparatus of claim 8, wherein the programming instructions further cause the processor to be configured to add the calculated quantity of steps to a total quantity of steps accumulated at an end of a previous step counting period of the step counting period.

10. The step counting apparatus of claim 8, wherein the target step counting criterion reference information comprises a parameter threshold corresponding to a specified parameter, and the programming instructions further causing the processor to be configured to:
calculate, based on the step counting information, a parameter value of the specified parameter; and
determine that the user is in the walking state in the step counting period when the parameter value of the specified parameter exceeds the parameter threshold of the specified parameter.

11. The step counting apparatus of claim 10, wherein the specified parameter comprises a difference between a probability that a wearing limb is in the walking state and a probability that the wearing limb is in a non-walking state.

12. The step counting apparatus of claim 10, wherein the specified parameter comprises a vibration frequency of a wearing limb.

13. The step counting apparatus of claim 10, wherein the specified parameter comprises a vibration amplitude of a wearing limb.

14. The step counting apparatus of claim 8, wherein the programming instructions further cause the processor to be configured to:
search for, based on the type of the target limb in the correspondence between the type of limb and a filtering manner, a target filtering manner corresponding to the target limb; and
perform a filtering process on the step counting information using the target filtering manner before determining whether the user is in the walking state in the step counting period.

15. A step counting method, wherein the method comprises:
collecting, by a step counting apparatus, wearing limb information, the wearing limb information comprising related characteristic information of a target limb on which a user wears the step counting apparatus;
determining, by the step counting apparatus based on the wearing limb information, a type of the target limb;
collecting, by the step counting apparatus in a step counting period, step counting information of the target limb;
searching for, by the step counting apparatus in a correspondence between a type of limb and a filtering manner, a target filtering manner corresponding to the target limb;
performing, by the step counting apparatus, filtering processing on the step counting information by using the target filtering manner, to determine filtered step counting information;
determining, by the step counting apparatus based on the filtered step counting information, whether the user is in a walking state in the step counting period; and
calculating, by the step counting apparatus, a quantity of steps based on the step counting information when determining that the user is in a walking state in the step counting period.
